(19) United States
(12) Patent Application Publication
(10) Pub. No.: US 2005/0193786 A1
(43) Pub. Date: Sep. 8, 2005

(54) Front loading lock assembly

(76) Inventor: Franklin T. Nakasone, Aliso Viejo, CA (US)

Correspondence Address: CARLSON, GASKEY & OLDS, P.C., 400 WEST MAPLE ROAD, SUITE 350, BIRMINGHAM, MI, 48009, US

(21) Appl. No.: 10/790,964

(22) Filed: Mar. 2, 2004

(51) Int. Cl. E05B 9/04

(52) U.S. Cl. 70/375; 70/368; 70/370

(57) ABSTRACT

A lock assembly includes a housing, a core assembly and a retainer. The housing includes a housing retainer groove located generally transverse to an axis defined by a bore through the housing, which corresponds with a core retainer groove. When the core assembly is mounted within the bore, the retainer grooves are aligned. The retainer is inserted into the grooves such that a bridge portion of the retainer is engaged by an engagement feature to secure the retainer and thereby mount the core assembly into the housing.

### BACKGROUND OF THE INVENTION

The present invention relates to a lock assembly, and more particularly to a mounting arrangement for a core assembly into a lock housing.

Numerous types of conventional lock assemblies are utilized for various applications.

Homes and commercial establishments are protected predominantly by key-actuated pin tumbler locks. In a typical lock, a core assembly houses a rotational cylindrical plug having a longitudinally extending keyway. A driving member such as a cam is connected to the rear face of the plug. The driving member actuates a bolt-throwing or latch-moving mechanism.

The interface between the plug and the core is called the shear line. A plurality of radially extending, parallel chambers is formed in the core and the plug. Spring-biased pins are disposed in each chamber. Under normal conditions, the drivers block the shear line, to prevent the plug from being rotated relative to the core. However, when a properly configured key is inserted into the keyway, the drivers and lower pins are moved so that the top of the lower pins and the bottom of the drivers meet at the shear line. The plug can then be rotated to cause rotation of the driving member and subsequent retraction or extension of the bolt or latch.

Locksmiths frequently rekey or replace residential or commercial locks. To this end, interchangeable core assemblies are manufactured by various lockmakers.

Disadvantageously, the interchangeable core assemblies are relatively complicated.

Typically, the interchangeable core assembly, even those from a single manufacturer, is specific to a particular lock type and include mounting structure specific thereto. For example, a knob lock assembly, a lever lock assembly, and deadbolt lock assembly each utilize a core assembly particular to a knob, a lever, and a deadbolt respectively. Such an arrangement complicates rekeying and replacement of residential and commercial locks.

Accordingly, it is desirable to provide mounting arrangement for a core assembly that is readily mounted into multiple lock types.

### SUMMARY OF THE INVENTION

The lock assembly according to the present invention includes a housing, a core assembly, and a retainer. The housing supports and protects the core assembly. The retainer is a generally flat U-shaped member with two legs and a bridge portion therebetween.

The housing includes a housing retainer groove located generally transverse to an axis defined by a bore through the housing. The housing retainer groove corresponds with a core retainer groove. When the core assembly is mounted within the bore, the retainer groves are aligned. The retainer is inserted into the grooves such that the bridge portion is engaged by an engagement feature to secure the retainer into the grooves and thereby mount the core assembly into the housing.

The present invention therefore provides an uncomplicated mounting arrangement for a core assembly, which is readily mounted into multiple lock types.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a front exploded view of a lock assembly according to the present invention;

FIG. 2 is a rear exploded view of a lock assembly according to the present invention;

FIG. 3 is a planar view of a retainer;

FIG. 4 is a rear perspective view of a lock assembly according to the present invention with the retainer partially installed;

FIG. 5 is an expanded view of FIG. 4;

FIG. 6 is a sectional view of a retainer engagement member;

FIG. 7 is a rear perspective view of a lock assembly according to the present invention with the retainer installed; and

FIG. 8 is an expanded view of FIG. 7.

### DETAILED DESCRIPTION OF THE PREFERRED EMBODIMENT

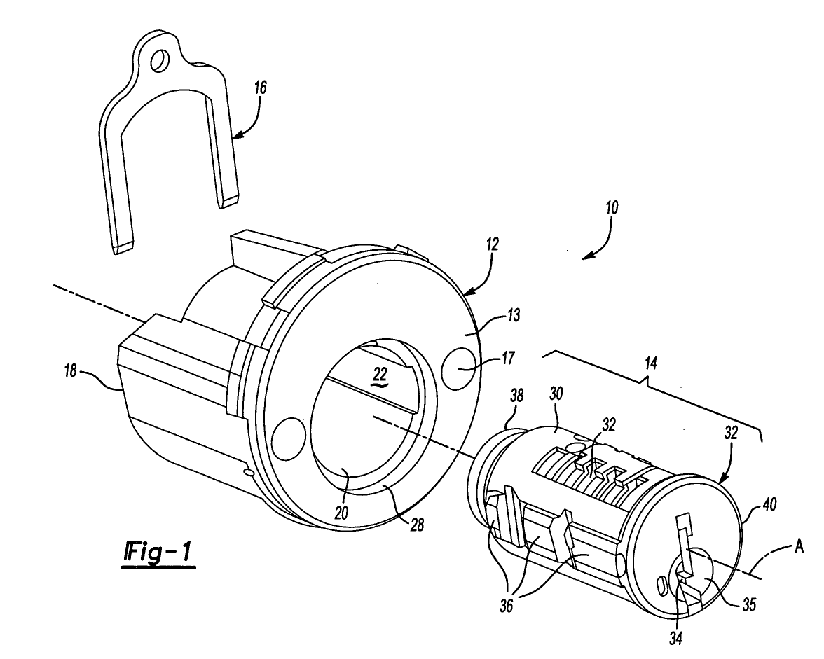

FIG. 1 illustrates a general exploded perspective view of a lock assembly 10. The lock assembly generally includes a housing 12, a core assembly 14 and a retainer 16. It should be understood that although a particular component configuration is disclosed in the illustrated embodiment, other arrangements will benefit from the instant invention.

The housing 12 supports and protects the core assembly 14. The housing 12 includes openings 17 for fasteners or the like to secure the housing 12 to a structure. Although a deadbolt housing is illustrated in the disclosed embodiment, it should be understood that other housings for other lock assemblies such as a lever, or knob will also benefit from the present invention.

The housing 12 includes a front face 13 and a rear face 18. It should be understood that relative positional terms such as “forward,” “aft,” “upper,” “lower,” “above,” “below,” and the like are with reference to the normal operational attitude and should not be considered otherwise limiting. A longitudinally extending bore 20 opens through the front and rear faces 13, 18 and defines an axis A. Elongate, open-ended grooves 22 are formed within the bore 20 generally parallel to the axis A. The grooves 22 are preferably open through the front and rear face 13, 18 and are parallel to axis A. A recessed face 28 within the front face 22 extends about the periphery of the bore 20.

The core assembly 14 includes a barrel 30 and a rotatable lock core 32. A keyway 34 is defined in a front face 35 of the lock core 32 to permit insertion of a key such that the lock core 32 can be rotated to operate the lock. Operation of the key to pin arrangement may take various conventional forms and need not be described in detail herein.

A core assembly extension 36 extends from the core assembly 14. The extension 36 is preferably formed as a portion of the barrel 30 to engage the grooves 22 to prevent relative rotation of the housing 12 and core assembly 14. The extension 36 also assists in guiding the core assembly 14 into the bore 20. The extension 36 may be formed in one or more portions to preferably form a rail structure along the longitudinal length of the core assembly 14. It should be understood that various extension shape and arrangements will benefit from the present invention.

An actuating member 24 is located within a rear portion 38 of the lock core 32 (FIG. 2) to engage an actuating plate (not shown) that extends through a latch bolt (not shown), which is conventional and need not described in detail herein.

A circumferential flange 40 (FIG. 2) is received within the recessed face 28 to control the axial insertion depth of the core assembly 14 into the housing 12.

Referring to FIG. 2, the housing 12 includes a housing retainer groove 42 located generally transverse to the axis A. The housing retainer groove 42 corresponds with a core assembly retainer groove 44, which is located transverse to axis A. The core assembly retainer groove 44 is preferably formed transversely through the extension 36.

When the core assembly 14 is mounted within the bore 20, the retainer groves 42, 44 are aligned (FIG. 4) through interaction of the circumferential flange 40 and the counter bore 28. That is, the core assembly 14 is pushed into the bore 20 until the circumferential flange 40 engages the counter bore 28 such that the retainer grooves 42, 44 are aligned.

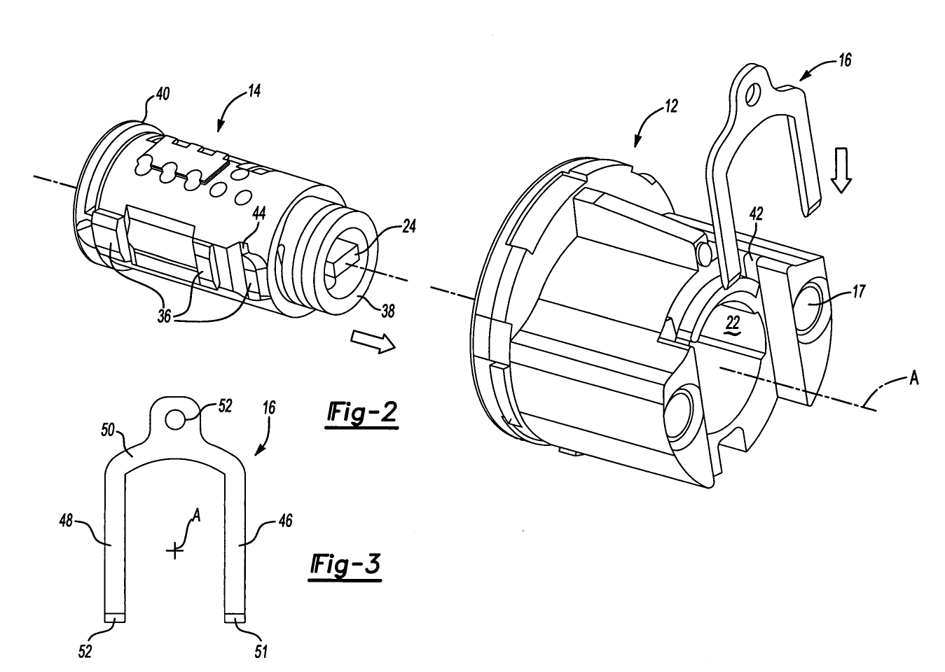

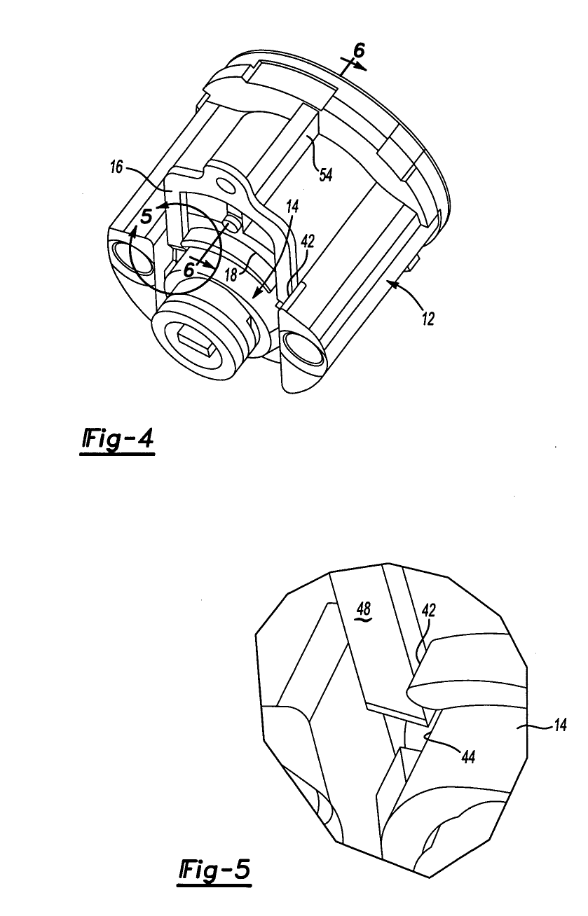

Referring to FIG. 3, the retainer 16 is preferably formed as a generally flat U-shaped member. It should be understood that other shapes will also benefit from the present invention. The retainer 16 includes a first leg 46, a second leg 48 and a bridge portion 50 therebetween. Each leg 46, 48 preferably include a bevel 51 at the end thereof to assist installation of the retainer 16 into the groove 42, 44 (FIG. 5). The bridge portion 50 preferably includes an aperture 52.

Referring to FIG. 4, the retainer 16 is partially inserted into the grooves 42, 44 such that the bridge portion 50 is just above a retainer engagement feature 54. The retainer engagement feature 54 is preferably formed along a top portion of housing 12 and extends toward the rear face 18 thereof.

Referring to FIG. 6, the retainer engagement feature 54 includes a detent 56. The detent 56 is located parallel to axis A.

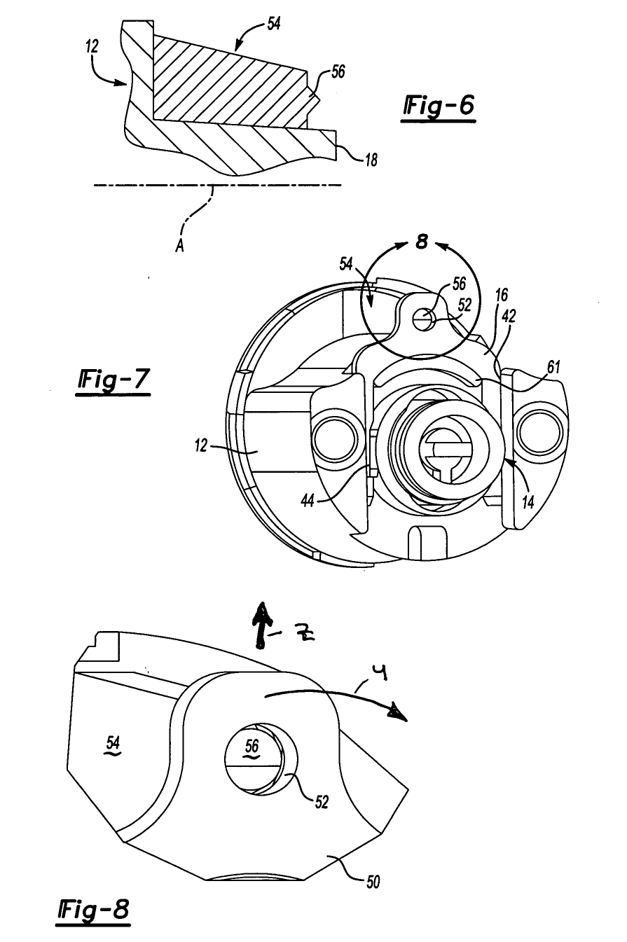

Referring to FIG. 7, as the retainer 16 is pushed into the grooves 42,44, the bridge portion of the retainer 16 engages the detent 56. The unique shape of detent 56 allows the bridge portion of 16 to slide into position, resting on feature 61. The retainer 16 is pushed into the grooves 43, 44 until the aperture 52 is aligned with the detent 56. When the aperture 52 is aligned with the detent 56, detent 56 secures retainer 16 into the grooves 42, 44 and thereby mounts the core assembly 14 within the housing 12. To remove the core assembly 14, the bridge retainer 16 is angled (illustrated schematically by arrow Y), then lifted at an angle (illustrated schematically by arrow Z), allowing aperture 52 to clear detent 56, and the retainer 16 is removed.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A lock assembly comprising:
a housing which defines an axis, said housing including a retainer engagement feature extending from said housing and a housing retainer groove;
a core assembly receivable within said housing along said axis; and
a retainer engageable with said housing retainer groove at an angle not perpendicular to said axis to initially pass over said retainer engagement feature extending from said housing during insertion of the retainer into the housing retainer groove and said core assembly transverse said axis to retain said core assembly within said housing.

2. The lock assembly as recited in claim 1, wherein said core assembly, includes a flange that is at least partially received within a frontal portion of said housing.

3. The lock assembly as recited in claim 1, wherein said housing comprises a groove generally parallel to said axis and said core assembly comprises a core assembly extension receivable within said groove to prevent rotation of said core assembly relative said housing.

4. The lock assembly as recited in claim 1, wherein said housing retainer groove is transverse said axis to receive said retainer.

5. The lock assembly as recited in claim 4, wherein said core assembly defines a core assembly retainer groove transverse said axis to receive said retainer.

6. The lock assembly as recited in claim 1, wherein said retainer is generally U-shaped.

7. The lock assembly as recited in claim 1, wherein said retainer comprises a first leg, a second leg and a bridge portion between said first leg and said second leg.

8. The lock assembly as recited in claim 7, further comprising an aperture located through said bridge portion.

9. The lock assembly as recited in claim 8, wherein said housing comprises a retainer engagement feature engageable with said aperture to retain said retainer within said housing.

10. The lock assembly as recited in claim 9, wherein said retainer engagement feature comprises an angled detent.

11. A front-loading lock assembly comprising:
a housing which defines an axis, said housing including a retainer engagement feature extending from said housing;
a core assembly receivable within said housing along said axis, said core assembly comprising a flange which engages said housing to locate said core assembly at a predetermined distance along said axis; and
a retainer engageable with said housing and said core assembly to retain said core assembly within said housing, said retainer receivable with a housing retainer groove at an angle not perpendicular to said axis to initially pass over said retainer engagement feature during insertion of the retainer into the housing retainer groove and a core assembly retainer groove transverse said axis.

12. The front loading lock assembly as recited in claim 11, wherein said retainer is generally U-shaped.

13. The front loading lock assembly as recited in claim 11, wherein said retainer comprises a first leg, a second leg and a bridge portion between said first leg and said second leg.

14. The front loading lock assembly as recited in claim 13, further comprising an aperture located through said bridge portion.

15. The front loading lock assembly as recited in claim 14, wherein said housing comprises a retainer engagement feature engageable with said aperture to retain said retainer within said housing.

16. The front loading lock assembly as recited in claim 15, wherein said retainer engagement feature comprises an angled detent.

17. A method of mounting a core assembly within a housing of a lock assembly comprising the steps of:
(a) inserting the core assembly within a bore in the housing along an axis;
(b) aligning a housing retainer groove and a core assembly retainer groove;
(c) inserting a retainer into the housing retainer groove at an angle not perpendicular to said axis to initially pass over a retainer engagement feature extending from the housing during insertion of the retainer into the housing retainer groove and the core assembly retainer groove transverse the axis; and
(d) selectively securing the retainer to the housing.

18. A method as recited in claim 17, wherein said step (d) further comprises:
aligning an aperture through the retainer with a retainer engagement feature extending from the housing.

19. A method as recited in claim 17, wherein said step (d) further comprises:
biasing an engagement detent extending from the housing at least partially through an aperture in the retainer.

20. A method as recited in claim 17, wherein said step (a) further comprises:
inserting the core assembly through a front face in the housing.

21. A lock assembly comprising:
a housing which defines an axis, said housing including a retainer engagement feature;
a core assembly receivable within said housing along said axis; and
a retainer engageable with said housing and said core assembly transverse said axis to retain said core assembly within said housing, said retainer includes a first leg, a second leg and a bridge portion between said first leg and said second leg, said bridge portion including an aperture engageable with said retainer engagement feature to retain said retainer within said housing.

22. A front-loading lock assembly comprising:
a housing which defines an axis, said housing including a retainer engagement feature;
a core assembly receivable within said housing along said axis, said core assembly comprising a flange which engages said housing to locate said core assembly at a predetermined distance along said axis; and
a U-shaped retainer engageable with said housing and said core assembly to retain said core assembly within said housing, said retainer receivable with a housing retainer groove and a core assembly retainer groove transverse said axis, said retainer includes a first leg, a second leg and a bridge portion between said first leg and said second leg, said bridge portion including an aperture engageable with said retainer engagement feature to retain said retainer within said housing.

23. A method of mounting a core assembly within a housing of a lock assembly comprising the steps of:
(a) inserting the core assembly within a bore in the housing along an axis;
(b) aligning a housing retainer groove and a core assembly retainer groove;
(c) inserting a retainer into the housing retainer groove such that a portion of the retainer initially passer over a retainer engagement feature extending from the housing and the core assembly retainer groove transverse the axis; and
(d) selectively securing the retainer to the housing by aligning an aperture through the retainer with a the retainer engagement feature extending from the housing.

24. A method of mounting a core assembly within a housing of a lock assembly comprising the steps of:
(a) inserting the core assembly within a bore in the housing along an axis;
(b) aligning a housing retainer groove and a core assembly retainer groove;
(c) inserting a retainer into the housing retainer groove and the core assembly retainer groove transverse the axis; and
(d) selectively securing the retainer to the housing by biasing an engagement detent extending from the housing at least partially through an aperture in the retainer.

25. The lock assembly as recited in claim 1, wherein said retainer comprises a first leg, a second leg and a bridge portion between said first leg and said second leg, each leg includes a bevel at an end thereof.

26. The front loading lock assembly as recited in claim 11, wherein said retainer comprises a first leg, a second leg and a bridge portion between said first leg and said second leg, each leg includes a bevel at an end thereof.

27. A method as recited in claim 17, wherein said step (c) further comprises:
reducing the angle as the retainer is inserted into the housing retainer groove.

28. The lock assembly as recited in claim 1, wherein said retainer engagement feature extending from said housing extends parallel to said axis.

29. The front-loading lock assembly as recited in claim 11, wherein said retainer engagement feature extending from said housing extends parallel to said axis.

30. The lock assembly as recited in claim 1, wherein said retainer engagement feature extending from said housing is wedge shaped.

31. The front-loading lock assembly as recited in claim 11, wherein said retainer engagement feature extending from said housing is wedge shaped.

32. The lock assembly as recited in claim 1, wherein said retainer is a rigid planar member.

33. The front-loading lock assembly as recited in claim 11, wherein said retainer is a rigid planar member.
